(19) United States
(12) Patent Application Publication
(10) Pub. No.: US 2017/0271968 A1
(43) Pub. Date: Sep. 21, 2017

(54) ELECTRIC MOTOR AND ELECTRIC APPARATUS USING SAME

(71) Applicant: Johnson Electric S.A., Murten (CH)

(72) Inventors: Yue LI, Hong Kong (CN); Chui You ZHOU, Shenzhen (CN); Xiao Ning ZHU, Shenzhen (CN); Yong WANG, Shenzhen (CN); Yong Gang ZHANG, Shenzhen (CN); Hong Liang YI, Shenzhen (CN); Ya Ming ZHANG, Shenzhen (CN)

(21) Appl. No.: 15/459,555

(22) Filed: Mar. 15, 2017

(30) Foreign Application Priority Data
Mar. 18, 2016 (CN) 2016 1015 7211.5
May 17, 2016 (CN) 2016 1033 2939.7

(51) Int. Cl. H02K 19/04; F04D 29/32; F04D 25/06; H02K 7/08; H02K 7/14

(52) U.S. Cl. CPC H02K 19/04; H02K 7/08; H02K 7/14; F04D 25/06; F04D 29/325

(57) ABSTRACT

An electric motor includes a stator and a rotor rotatably mounted to the stator. The rotor includes a rotary shaft; a rotor main body attached around the rotary shaft, the rotor main body and the rotary shaft being loosely fit with each other thus allowing for a rotation speed difference therebetween; and a buffering device arranged between the rotor main body and the rotary shaft for synchronizing rotation speeds of the rotor main body and the rotary shaft in a time-delayed manner. The motor is preferably a single phase synchronous motor. An electrical apparatus using the motor is also provided.

### CROSS REFERENCE TO RELATED APPLICATIONS

This non-provisional patent application claims priority under 35 U.S.C. §119(a) from Patent Application No. 201610157211.5 filed in The People's Republic of China on Mar. 18, 2016, and Patent Application No. 201610332939.7 filed in The People's Republic of China on May 17, 2016.

### FIELD OF THE INVENTION

The present invention relates to the field of motors, and in particular to a single phase motor and an electric apparatus such as a fan assembly employing the motor.

### BACKGROUND OF THE INVENTION

Driving a fan/impeller using a motor is common in applications such as ventilation fans or dishwashers. Currently, in the common practice of driving the fan using the motor, the fan is mounted to a rotary shaft of the motor and driven by the motor to rotate. When the load has a large rotational inertia, motor startup failure may occur due to the incapability of the motor in providing sufficiently large rotational torque at the moment of the startup thereof, which may therefore damage the motor.

The issue described above is more likely to occur if the motor is a synchronous motor or another motor having small output torque. In order to address the startup issue, the applicant has previously proposed to arrange a buffering device between the rotary shaft and the fan. However, mounting the buffering device at an outside of the motor may make it troublesome to assemble and replace the fan, which makes the assembly and maintenance more difficult.

### SUMMARY OF THE INVENTION

Thus, there is a desire for a motor such as a single phase motor which can facilitate assembly and replacement parts thereof.

In one aspect, a single phase motor is provided which comprises a stator and a rotor rotatably mounted to the stator. The rotor comprises a rotary shaft; a rotor main body attached around the rotary shaft, the rotor main body and the rotary shaft being loosely fit with each other thus allowing for a rotation speed difference therebetween; and a buffering device arranged between the rotor main body and the rotary shaft for synchronizing with time delay rotation speeds of the rotor main body and the rotary shaft.

Preferably, the stator comprises a stator core and a stator winding wound on the stator core, and the rotor main body comprises permanent magnetic poles formed by permanent magnetic material or a conductor made of soft magnetic material such that the rotor main body is capable of rotating under interaction between the rotor main body and the stator.

Preferably, the stator comprises a stator core, a stator winding wound on the stator core and a pair of end caps disposed on opposite sides of the stator core, the buffering device being axially disposed between the end caps.

Preferably, the motor further includes a pair of bearings mounted in the end caps respectively, and the rotary shaft is rotatably mounted to the end caps via the bearings, the buffering device being axially located between the stator core and one of the end caps.

Preferably, the rotor further comprises a support member, the rotor main body is mounted on the support member, the support member is attached around the rotary shaft, one end of the buffering device is connected to the support member, and the other end of the buffering device is connected to the rotary shaft.

Preferably, the support member comprises an extension portion extending from one end of the support member, a receiving space being formed between the extension portion and the rotary shaft, the buffering device being received within the receiving space.

Preferably, the rotor further comprises a tube made of abrasion resistant material, the tube being radially arrange between the rotor main body and the rotary shaft.

Preferably, the buffering device is attached round one end of the tube extending out of the rotor main body such as rotor core and/or magnets.

Preferably, the motor further comprises a sleeve made from a vibration damping material, the sleeve is attached around a portion of the tube extending out of the rotor main body, and the buffering device is attached around the sleeve.

Preferably, the motor further comprises an end cap attached to one end of the stator core and a mounting base, one end of the rotary shaft is rotatably mounted to the end cap and the other end of the rotary shaft is connected to the mounting base for rotating with the mounting base synchronously, the rotor further comprises a support member movably attached around the rotary shaft, the rotor main body is fixedly mounted on the support member, the support member comprises an extension portion extending from one end of the support member away from the end cap, a receiving space is formed between the rotary shaft and the extension portion, and the buffering device is received in the receiving space with one end of the buffering device connected to the support member and the other end of the buffering device connected to the mounting base.

Preferably, the buffering device comprises a helical spring attached around the rotary shaft.

Preferably, the motor further comprises a positioning member and a vibration damping ring, the positioning member is fixed to a portion of the rotary shaft extending out of the rotor main body for limiting axial movement of the rotor main body relative to the rotary shaft, and the vibration damping ring is disposed between the rotor main body and the positioning member.

Preferably, the motor is a single phase synchronous motor.

Preferably, the buffering device is located within the rotor main body and radially between the rotary shaft and the rotor main body.

Preferably, the buffering device includes a buffering member movably attached round the rotary shaft and a damping member, the damping member is movably attached around the buffering member and located between the buffering member and the rotor main body.

Preferably, the buffering device further comprises a first connecting base and a second connecting base connected respectively to two ends of the buffering member, the first connecting base is connected to the rotor main body, and the second connecting base is connected to the rotary shaft.

Preferably, the rotor further comprises a support member, the rotor main body is mounted on the support member, the support member is attached around the rotary shaft, the buffering member, the damping member and the first and second connecting bases being arranged within the support member.

Preferably, the buffering member and the first connecting base are movably attached around the rotary shaft, and the second connecting base is fixedly attached around the rotary shaft.

In another aspect, an electric apparatus is provided. The electric apparatus comprises a motor which comprises a stator; a rotor comprising a rotary shaft, and a rotor main body attached around the rotary shaft, the rotor main body capable of rotation under action of the stator, the rotor main body and the rotary shaft being loosely fit with each other such that the rotor main body is capable of rotation relative to the rotary shaft during startup of the motor; and a buffering device having one end directly and indirectly connected to the rotor main body and the other end directly or indirectly connected to the rotary shaft for synchronizing rotation speeds of the rotor main body and the rotary shaft in a time-delayed manner; and a load mounted to one end of the rotary shaft of the motor and being capable of synchronous rotation with the rotary shaft.

Preferably, the electrical apparatus comprises a fan or impeller to which the rotary shaft of the motor is mounted.

In the single phase motor of the embodiments of the present invention, the rotor main body drives the rotary shaft to rotate via the buffering device, and the rotary shaft in turn drives the load to rotate. The buffering device effectively alleviates the large impact imposed on the load such as fan or impeller by the single phase motor at the moment of startup thereof, and addresses the startup failure issue due to incapability of the single phase motor in providing sufficiently large rotational torque at the moment of the startup thereof. In addition, the buffering device is disposed in an interior of the motor, and the load fan is directly connected to one end of the rotary shaft, which makes the motor structure more compact, and also facilitates maintenance and replacement parts of the motor.

### BRIEF DESCRIPTION OF THE DRAWINGS

FIG. 1 is a perspective view of a single phase motor according to a first embodiment of the present invention, which is applied in a fan assembly.

FIG. 2 is an exploded view of the fan assembly of FIG. 1.

FIG. 3 is an exploded view of the fan assembly of FIG. 1, viewed from another aspect.

FIG. 4 is a sectional view of the fan assembly of FIG. 1, taken along line IV-IV thereof.

FIG. 5 is a partially sectional view of the fan assembly of FIG. 1.

FIG. 6 is a sectional view of a single phase motor according to a second embodiment of the present invention.

FIG. 7 is a sectional view of the single phase motor of FIG. 6, viewed from another aspect.

FIG. 8 is a sectional view of the single phase motor of FIG. 6, with a connecting member assembled.

FIG. 9 is a sectional view of a single phase motor according to a third embodiment of the present invention.

FIG. 10 is a sectional view of a single phase motor according to a fourth embodiment of the present invention.

FIGS. 11 to 18 illustrate a motor in accordance with a fifth embodiment of the present invention.

FIG. 19 illustrates a fan assembly using the motor of FIGS. 11 to 18.

The present invention will be further described below with reference to the above drawings and the following embodiments.

### DETAILED DESCRIPTION OF THE PREFERRED EMBODIMENTS

Various embodiments of the present invention will be described as follows with reference to the accompanying drawings. Elements of similar structures or functions are generally represented by like reference numerals for illustrative purposes throughout the specification and figures. The figures are for the purposes of illustration only and should not be regarded as limiting. The figures are not drawn to scale and do not illustrate every aspect of the described embodiments. Unless otherwise specified, all technical and scientific terms have the ordinary meaning as commonly understood by people skilled in the art.

It is noted that, when a component is described to be “fixed” to another component, it can be directly fixed to the another component or there may be an intermediate component. When a component is described to be “connected” on another component, it can be directly connected to the another component or there may be an intermediate component. When a component is described to be “disposed” on another component, it can be directly disposed on the another component or there may be an intermediate component.

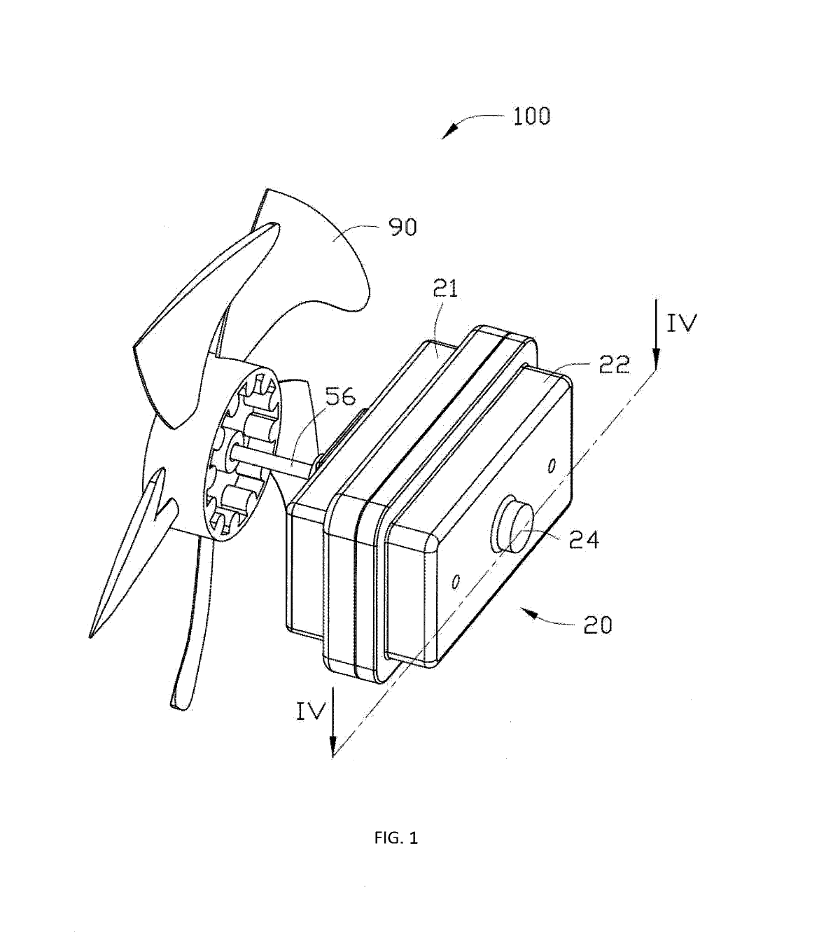

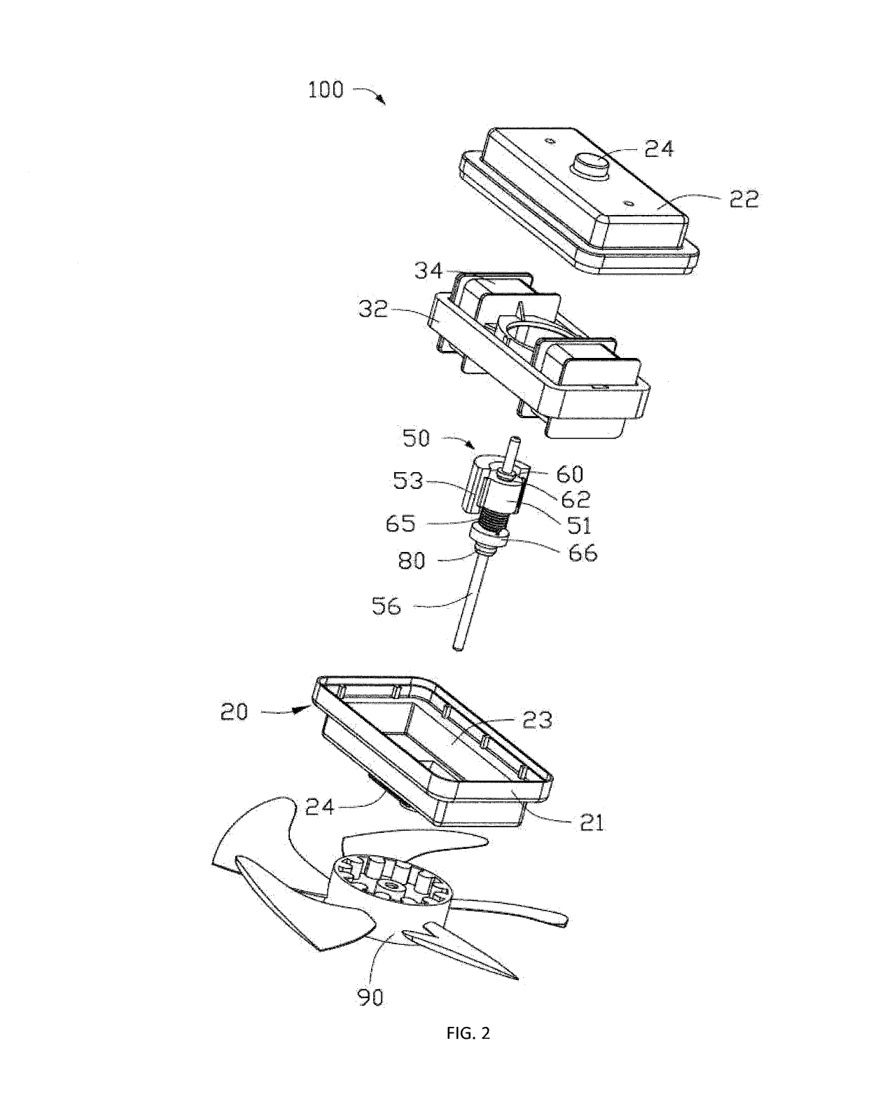

Referring to FIG. 1 and FIG. 2, a single phase motor 10 used in a fan assembly 100 in accordance with a first embodiment of the present invention is used to drive a load, e.g. a fan 90, to rotate. In this embodiment, the single phase motor 10 is preferably a single phase synchronous motor which at least includes a housing 20, and a stator 30 and a rotor 50 mounted in the housing 20. In this embodiment, the housing 20 includes an upper end cap 21 and a lower end cap 22 that are substantially identical in shape. The upper end cap 21 and the lower end cap 22 cooperatively define an accommodating space 23 for accommodating the stator 30 and the rotor 50. A top portion of the upper end cap 21 and a bottom portion of the lower end cap 22 are each provided with an accommodating portion 24 for accommodating a bearing 80.

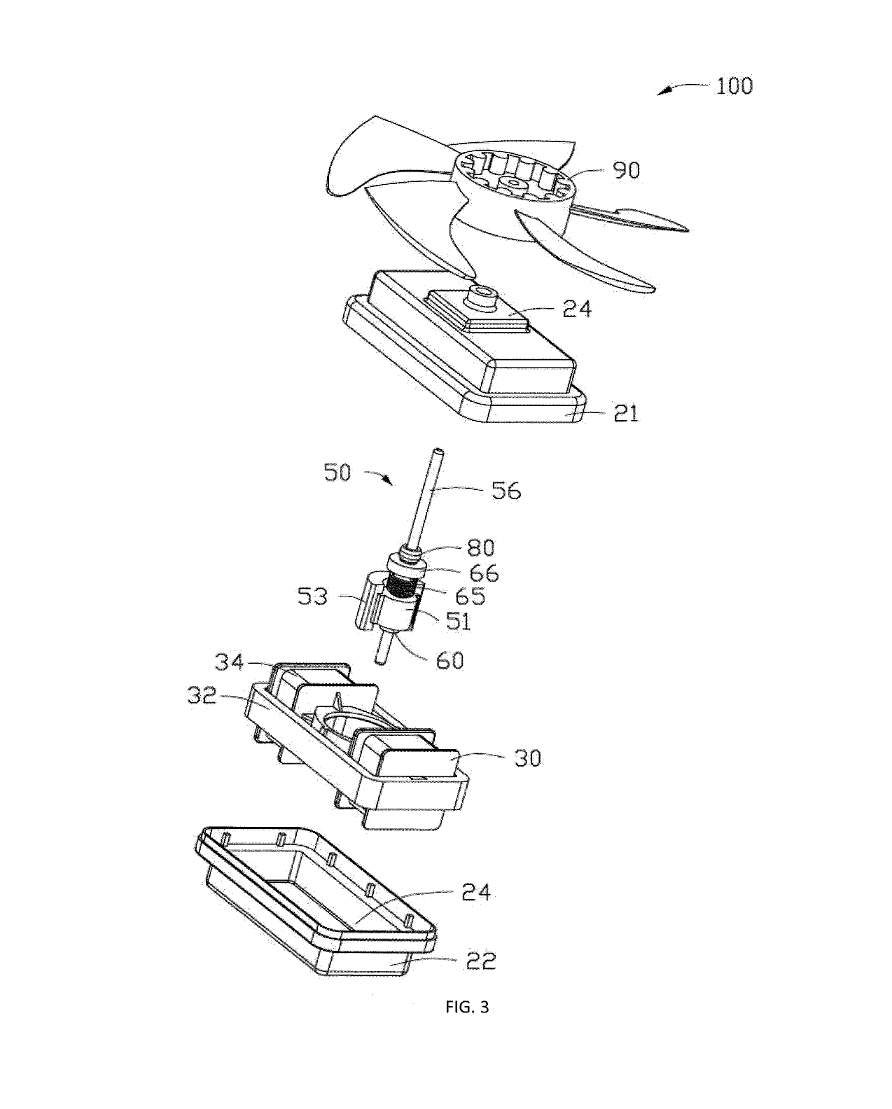

Referring to FIG. 2 and FIG. 3, the stator 30 is mounted in an interior of the accommodating space 23 defined by the housing 20. The stator 30 includes a stator core 32 and a stator winding 34 wound around the stator core 32. The stator winding 34 is supplied with a single phase electrical current. The two end caps 21, 22 are mounted to two axial sides of the stator core 32, respectively. The upper end cap 21 and the lower end cap 22 of the housing 20 can be connected together in a manner including, but not limited to, snap-fitting and screw-fastening.

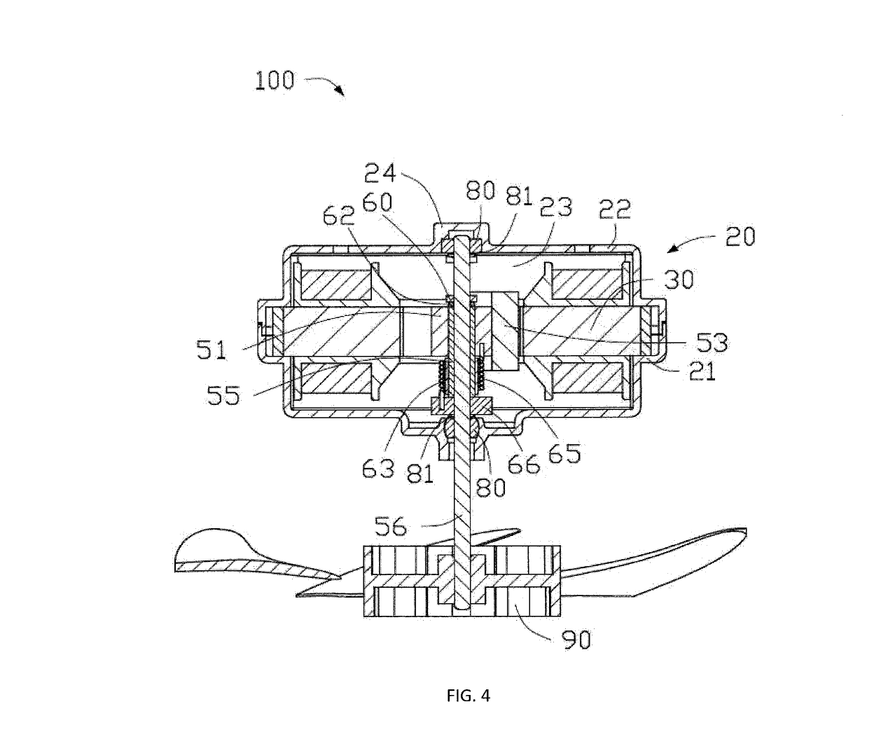

The rotor 50 rotatably received in the stator 30, includes a rotor main body, a tube 55 (FIG. 4), and a rotary shaft 56. The rotor main body (not labeled) is attached and loosely fit around the rotary shaft 56. In the present embodiment, the rotor main body includes a rotor core 51 and a permanent magnet 53 mounted to a circumferential side of the rotor core 51. The tube 55 axially passes through and is fixed in the rotor core 51, such that the tube 55 is rotatable along with the rotor core 51. The rotary shaft 56 passes through and is rotatable relative to the tube 55. One end of the rotary shaft 56 extending out of the tube 55 is mounted to the bearing 80 in the lower end cap 22, and the other end of the rotary shaft 56 passes through the bearing 80 in the upper end cap 21 to connect with the fan 90. In operation, the rotor main body rotates to drive the rotary shaft to rotate, which in turn drives a load connected to one end of the rotary shaft 56 to rotate, the load being the fan 90 in the present embodiment.

It should be understood that, in some embodiments, the permanent magnet 53 may be directly mounted to an outer side of the tube 55 or the rotary shaft 56 and formed as a cylindrical body. The cylindrical body formed by the permanent magnet 53 has an axis coinciding with axes of the tube 55 and the rotary shaft 56. The tube 55 is made wear/abrasion resistant material for protecting the rotor core or magnets from being damaged during rotation of the rotor main body relative to the rotary shaft.

Referring to FIG. 4, the single phase motor 10 further includes at least one positioning member 60, a plurality of vibration damping rings 62, a sleeve 63, a resilient element 65, and a connecting member 66. The positioning member 60 is attached around a portion of the rotary shaft 56 extending out of the rotor core 51 in a direction toward the lower end cap 22. The positioning member 60 is fixedly connected with the rotary shaft 56 to limit axial movement of the tube 55 toward one end of the rotary shaft 56. One of the vibration damping rings 62 is attached around the rotary shaft 56 and disposed between the positioning member 60 and the tube 55 to reduce vibrations generated when the rotor core 51 and the tube 55 drive the rotary shaft 56 to rotate.

The sleeve 63 is attached around the portion of the tube 55 extending out of the rotor core 51 and toward the upper end cap 21. Preferably, the sleeve 63 is fixedly connected with the tube 55. One end of the resilient element 65 is connected to one end of the rotor core 51 of the rotor main body opposite from the positioning member 60, and the other end of the resilient element 65 is connected to the connecting member 66. In the present embodiment, the sleeve 63 is made from a rubber-like vibration damping material and has a smooth outer cylindrical surface. The resilient element 65 is attached around the sleeve 63 which can reduce vibrations of the resilient element 65 transferred to the tube 55. Preferably, the resilient element 65 has an inner diameter greater than an outer diameter of the sleeve 63. In the present embodiment, the resilient element 65 is a torsion spring.

In the present embodiment, the connecting member 66 is generally a hollow annular structure, which is attached around the portion of the rotary shaft 56 extending out of the tube 55 in a direction toward the upper end cap 21. The connecting member 66 is disposed between the tube 55 and the upper end cap 21. In particular, one end of the connecting member 66 abuts against one end of the tube 55 opposite from the rotor 50, and the other end of the connecting member 66 abuts against an inner side of the upper end cap 21. The connecting member 66 is fixedly mounted on the rotary shaft 56, such that the connecting member 66 can drive the rotary shaft 56 for synchronous rotation. It should be understood that the connecting member 66 and the rotary shaft 56 may also be movably connected in another connection manner such as through splines, as long as they are capable of synchronous rotation.

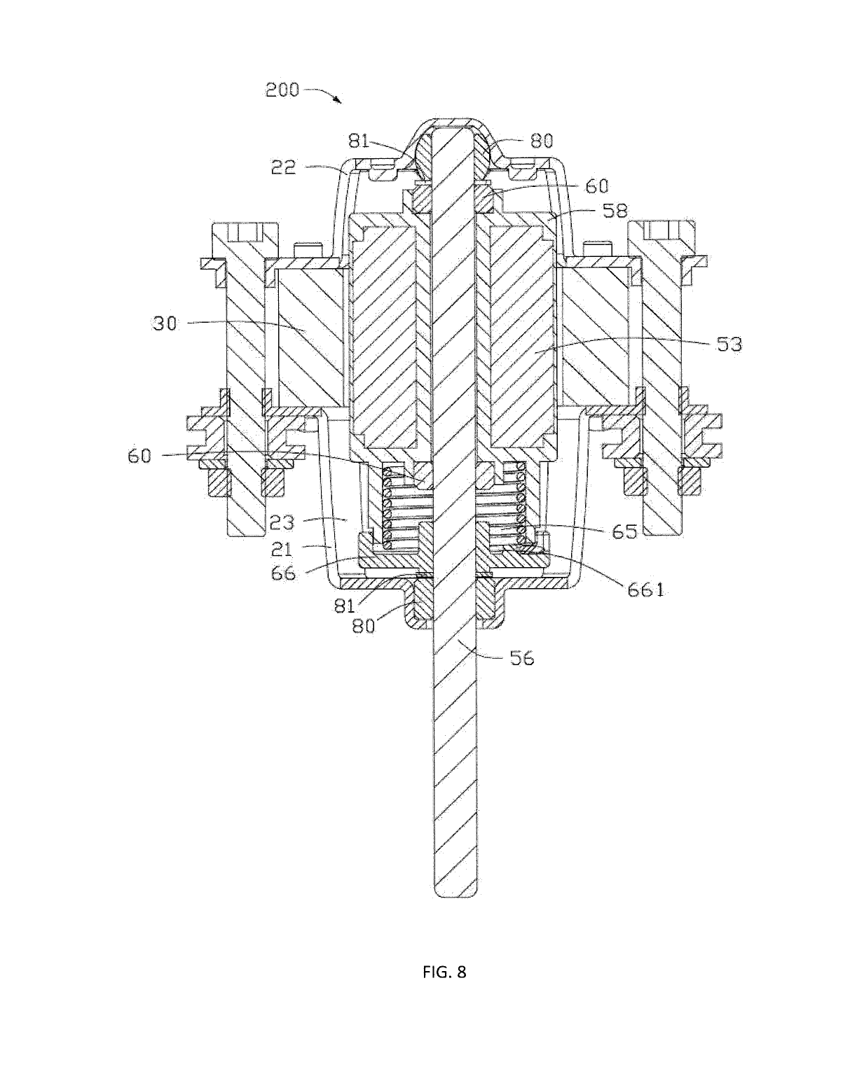

It should be understood that, referring to FIG. 8, the connecting member 66 may also be provided with a groove 661 and a retaining member (not labeled) at a side of the connecting member 66 facing the rotor 50. The groove 661 is used to receive the resilient element 65, and the retaining member is used to retain one end of the resilient element 65.

In the present embodiment, the connecting member 66 is disposed at an inside of the upper end cap 21 such that the structure of the single phase motor 10 is more compact, and the connection between the single phase motor 10 and the load is more convenient.

A washer 81 is disposed at a side of each bearing 80 facing the rotor 50. The washer 81 is attached around the rotary shaft 56 to prevent dusts, impurities, harmful gas from entering the bearing 80. The washer 81 may also be used to adjust axial clearance to reduce axial runout of the rotary shaft 56.

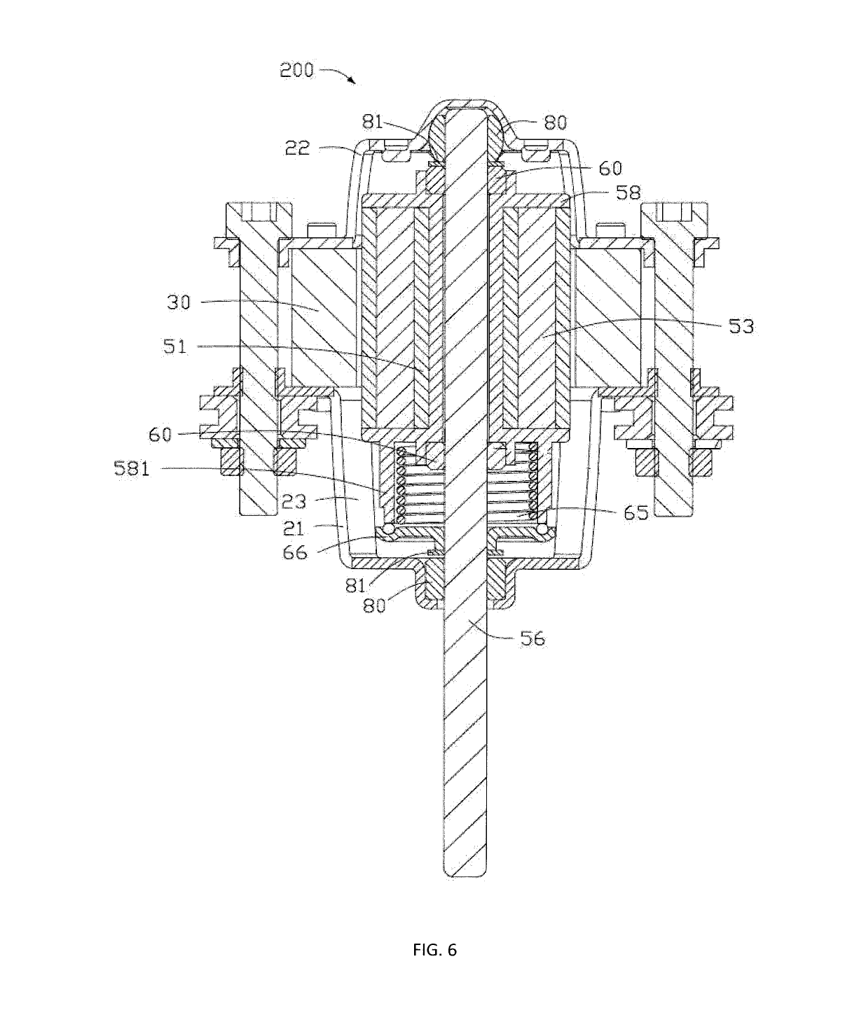

Referring to FIG. 6, a second embodiment of the present invention differs from the first embodiment in that, the single phase motor 200 includes a support member 58 attached around and rotatably fit with the rotary shaft 56. The rotor main body is fixedly mounted on the support member 58. In the present embodiment, the support member 58 is a plastic-made structural member of the rotor, with an extension portion 581 extending from one end of the support member 58. A receiving space is formed between the extension portion 581 and the rotary shaft 56, for receiving the resilient element 65 to prevent the resilient element 65 from interfering with other surrounding parts during deformation of the resilient element 65. During the course of stopping of the motor rotation, the rotary shaft 56 and the load continue rotating due to inertia, which reversely twists the resilient element 65, making the resilient element 65 to increase in radius. The extension portion 581 may prevent the resilient element 65 from being damaged due to excessive increase in the radius of the resilient element 65 during this course.

In the present embodiment, the permanent magnet 53 of the rotor main body may include two semi-circular magnets embedded in the rotor core 51, or may alternatively be an integral ring magnet attached around an outer circumference of the rotor magnet core 51. The single phase motor 200 includes two positioning members 60. The two positioning members 60 are attached around the rotary shaft 56 and disposed at two ends of the support member 58 to limit axial movement of the support member 58 on the rotary shaft 56.

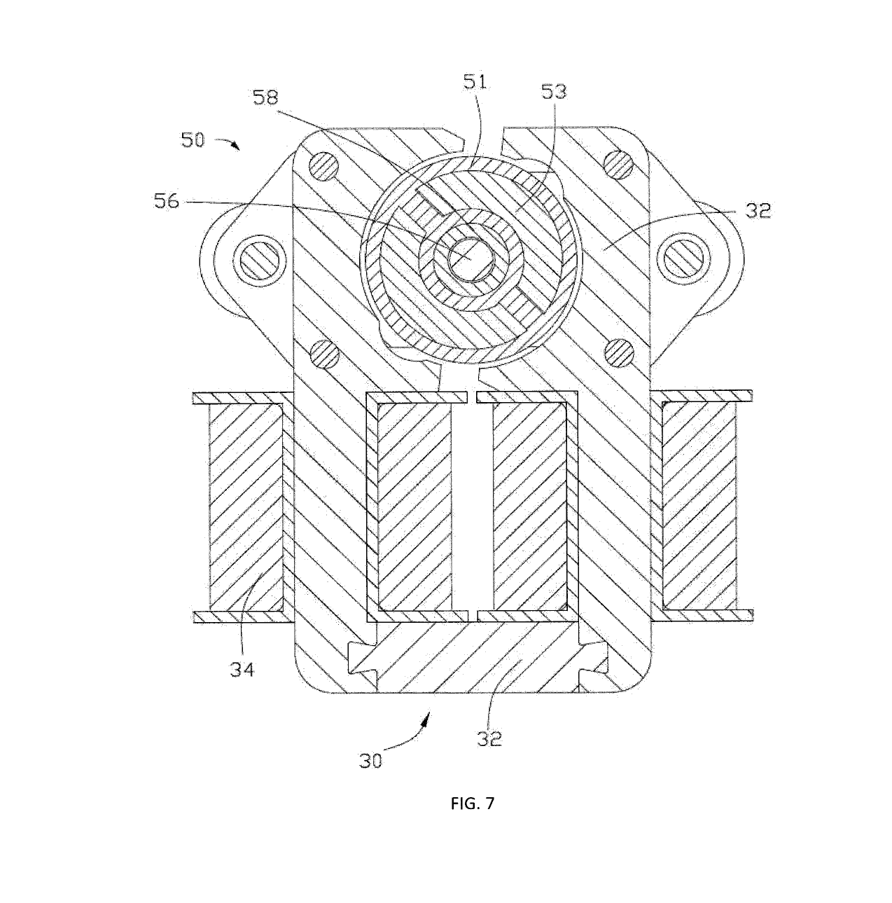

Referring to FIG. 7, it should be understood that, the rotor main body may also be an interior permanent magnet (IPM) rotor structure, in which multiple permanent magnets 53 are directly embedded in the rotor core 51. The stator core 32 includes multiple stator poles surrounding an outer circumference of the rotor main body. Preferably, the number of the stator poles is equal to the number of permanent magnetic poles defined by the rotor permanent magnets. A pole face of each stator pole confronting the rotor 50 is formed with a positioning groove, such that the rotor 50 can stop at a position offset from a dead-point position.

It should be understood that, in some embodiments, the permanent magnets 53 of the rotor main body may be directly mounted to an outer side of the support member 58 to form a cylindrical body. The cylindrical body formed by the permanent magnets 53 has an axis coinciding with an axis of the support member 58 (FIG. 8).

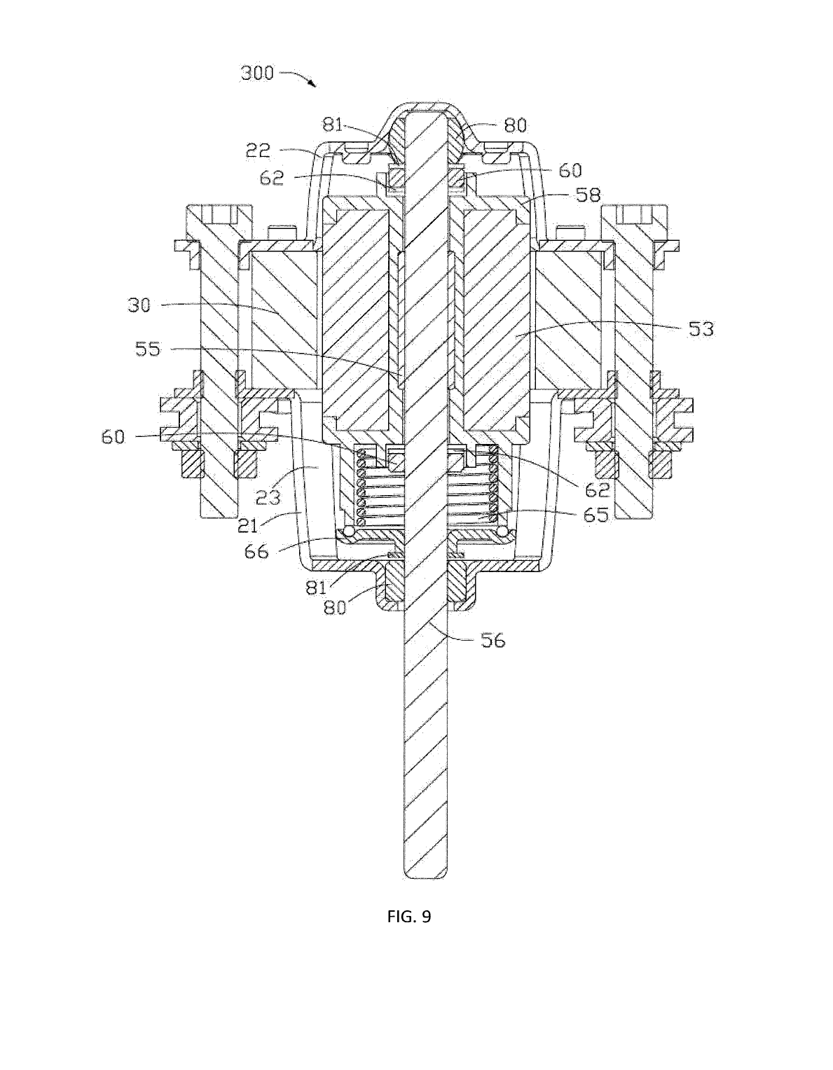

Referring to FIG. 9, a third embodiment of the present invention differs from the second embodiment in that, the tube 55 of the single phase motor 300 is fixedly inserted in an shaft hole (not labeled) of the support member 58, and an axis of the tube 55 coincides with the axis of the support member 58. The tube 55 is attached around and slidable relative to the rotary shaft 56, such that the rotor main body drives the support member 58 and the tube 55 to rotate around the rotary shaft 56. In this embodiment, the support member 58 is preferably injection molded to connect the permanent magnets 53 of the rotor main body and the tube 55 together. When the rotor main body further includes a rotor core 51, the support member 58 is preferably injection molded to connect the assembled rotor core 51 and permanent magnets 53 and the tube 55 together. Preferably, the tube 55 is made from a wear resistant material such as copper, steel or wear resistant alloy, or is alternatively made by power sintering. The single-phase motor 300 includes two positioning members 60. The two positioning members 60 are attached around the rotary shaft 56 and disposed at two ends of the support member 58 to limit axial movement of the support member 58 on the rotary shaft 56.

It should be understood that, in all embodiments described above, the single phase motor 300 may be of an inner rotor type in which the rotor is disposed inside the stator, or of an outer rotor type in which the rotor is disposed outside the stator. The support member 58 may be formed by injection molding or by latching means to wrap around the outer side of the rotor core 51 and the permanent magnets 53 or the outer side of the permanent magnets 53.

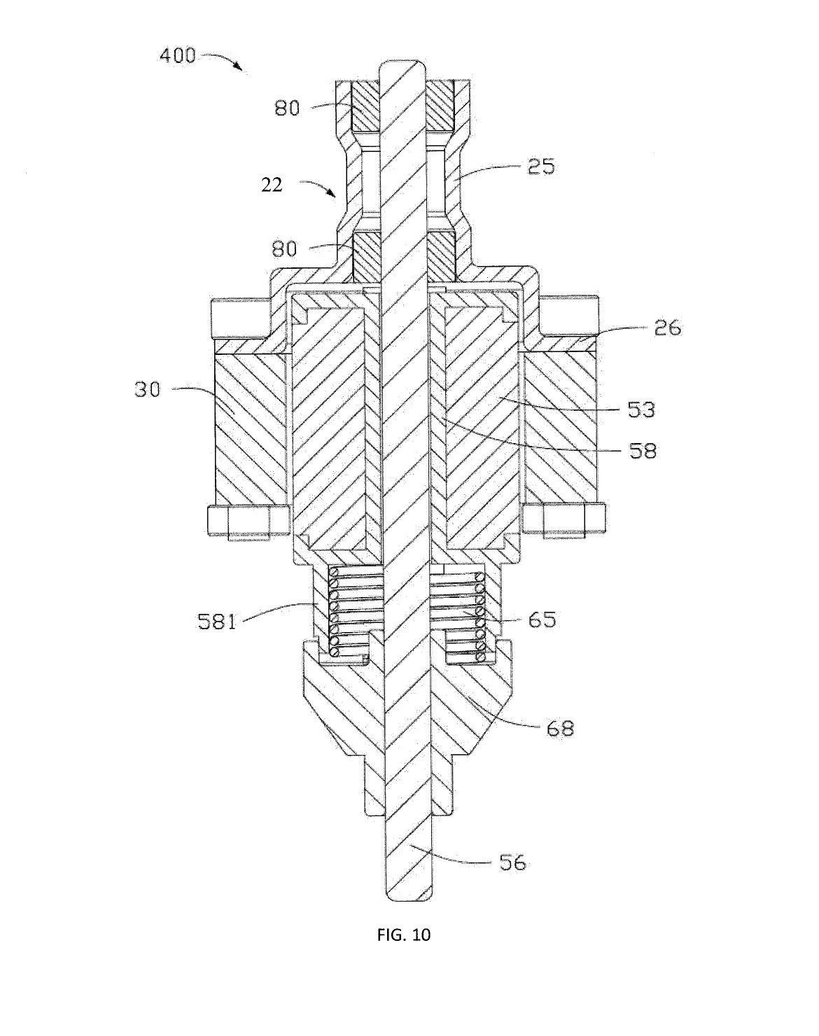

Referring to FIG. 10, a fourth embodiment of the present invention differs from the third embodiment in that, the stator 30 is positioned by an end cap 22. The end cap 22 is fixed to one side of the stator 30. The end cap 22 includes a hollow tube portion 25 and a fixing plate 26 positioned at one side of the tube portion 25. The tube portion 25 allows part of the rotor main body to be received therein. The fixing plate 26 is connected to one side of the rotor core 32 through fixing members such as screws or latching members.

The tube portion 25 includes two bearing seats (not labeled) for mounting two bearings 80, respectively. The rotary shaft 56 of the rotor is supported by the two bearings 80 such that the rotor is capable of rotation relative to the stator 30. In this embodiment, the two bearings 80 are spaced apart by a preset distance to stably support the rotary shaft 56. The rotor main body, the support member 58, the positioning member 60 and the resilient element 65 are disposed at the same side of the two bearings 80.

The present embodiment differs from the above embodiments in that, the single phase motor 400 includes a mounting base 68. The mounting base 68 is attached around the portion of the rotary shaft 56 opposite from the housing 20 and is fixed relative to the rotary shaft 56 in the circumferential direction. One end of the resilient element 65 is connected to the support member 58, and the other end of the resilient element 65 is connected to the mounting base 68. One end of the mounting base 68 opposite from the support member 58 may connect to a load such as a fan or impeller.

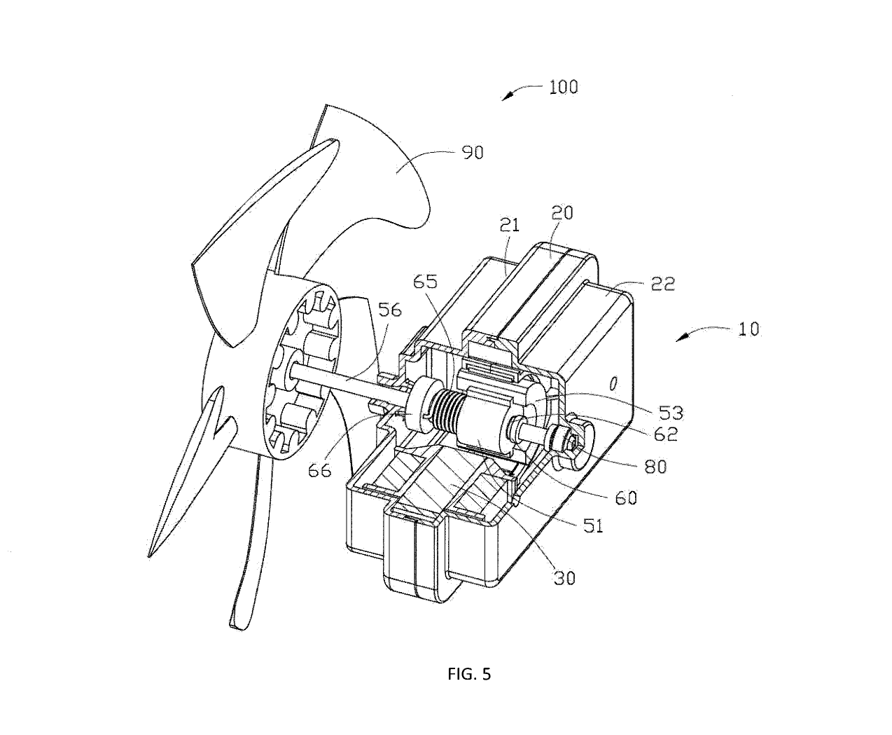

Taking the first embodiment of the present invention as an example, referring to FIG. 4 and FIG. 5, the single phase motor 10 of the present invention drives the fan 90 to rotate as follows. When the stator winding 34 is energized, the rotor main body 51, 53 together with the tube 55 fixedly connected to the rotor core 51 rotate about the rotary shaft 56 under the interaction between the rotor main body and the stator. The end of the resilient element 65 connected with the rotor core 51 rotates with the rotor core 51 synchronously. Since the connecting member 66 and the rotary shaft 56 connected to the fan 90 are stationary during an initial period of the startup of the single phase motor 10 and have a large inertia, the other end of the resilient element 65 connected with the connecting member 66 is also stationary or in a delayed state. One end of the resilient member 65 is pulled to decrease its inner diameter and elastic potential energy progressively accumulates in the resilient element 65. When the elastic potential energy of the resilient element 65 becomes sufficiently large (e.g. to overcome friction between the rotary shaft 56 and the bearings 80), the connecting member 66 and the rotary shaft 56 will be accelerated by the resilient element 65 and eventually rotate synchronously with the rotor magnet 53 and the rotor core 51. The fan 90 also rotates synchronously with the rotary shaft 56. Thus, the rotary shaft 56 and fan 90 is finally time delayed synchronous with the rotor main body 51, 53.

It should be understood that the single phase motor 10 may also include a housing within which the stator 30 and the rotor 50 are mounted. There is one end cap 20 connected to the housing to support the rotary shaft 56 of the single phase motor 10. The shape of the end cap 20 may be adapted to match with the shape and size of the housing.

It should be understood that, in other embodiments of the present invention, the resilient element 65 may be connected to the rotor core 51 and the rotary shaft 56 in a different manner. For example, the connecting member 66 may be omitted, in which case one end of the resilient element 65 is connected to the rotor core 51 and the other end is connected to the rotary shaft 56. The rotor core 51 drives the rotary shaft 56 to rotate via the resilient element 65, thereby alleviating the impact imposed on the load by the single phase motor 10 at the moment of startup thereof.

It should be understood that, in the embodiments of the single phase motor of the present invention, when the resilient element 65 is a torsion spring or coil spring, with one end connected to the rotor core 51 or the permanent magnets 53 or the support member 58, and the other end connected to the connecting member 66 or the mounting base 68, each of the rotor core 51, the permanent magnet 53, the support member 58, the connecting member 66 and the mounting base 68 is formed with a retaining portion or locking groove for retaining the resilient element 65.

The rotor 50 of the present invention preferably includes one or multiple permanent magnets forming multiple permanent magnetic poles. It should be understood that the present invention may be applied in a non-permanent magnet motor. That is, the rotor 50 does not include a permanent magnet; rather, the rotor 50 uses multiple conductors made of soft magnetic material. Upon being energized, the stator winding produces an electromagnetic field, and the conductors of the rotor are therefore magnetized and driven to rotate under the action of the magnetic field.

In the single phase motor 10 of the present invention, the rotor main body (including the rotor core and/or the permanent magnets or conductors) drives the rotary shaft 56 to rotate via the resilient element 65 which acts as a buffering device, and the rotary shaft 56 in turn drives the load to rotate. Buffering action of the resilient element 65 effectively alleviates the large impact imposed on the fan 90 by the single phase motor 10 at the moment of startup thereof, and addresses the startup failure issue due to incapability of the single phase motor 10 in providing sufficiently large rotational torque at the moment of the startup thereof. In addition, the resilient element is disposed in an interior of the motor housing 20, and the load such as a fan 90 is directly connected to one end of the rotary shaft 56 extending out of the housing 20, which makes the structure of the single phase motor 10 more compact, and also facilitates maintenance and replacement of the fan 90.

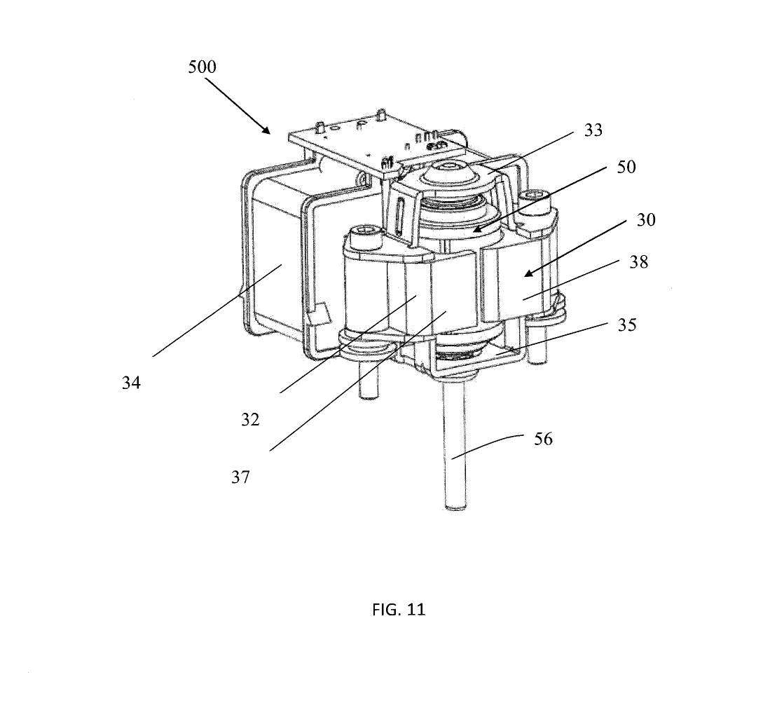

FIGS. 11 to 18 illustrate a motor 500 in accordance with a fifth embodiment of the present invention.

Referring to FIG. 11, the motor 500 includes a stator 30 and a rotor 50. The rotor 50 is rotatably mounted to the stator 30 for rotation relative to the stator 30.

In this embodiment, the stator 30 includes a stator core 32, a winding 34 wound around the stator core 32, and a first end cap 33 and a second end cap 35 respectively mounted to two axial sides of the stator core 32. The first end cap 33 and the second end cap 35 are configured to support a rotary shaft 56 of the rotor 50. The first end cap 33 and the second end cap 35 are interconnected through an axial connecting mechanism so as to sandwich the stator core 32 between the first and second end caps 33, 35. In this embodiment, each of the first end cap 33 and the second end cap 35 is an integrally formed part. The connecting mechanism 37 may includes a screw and an associated screw nut. The first end cap 33 and the second end cap 35 form through holes for allowing the screw to pass therethrough. Alternatively, the connecting mechanism 37 may further include a positioning sleeve attached around the screw and disposed between the first end cap 33 and the second end cap 35 for positioning and supporting the first and second end cap 33 and improving the appearance.

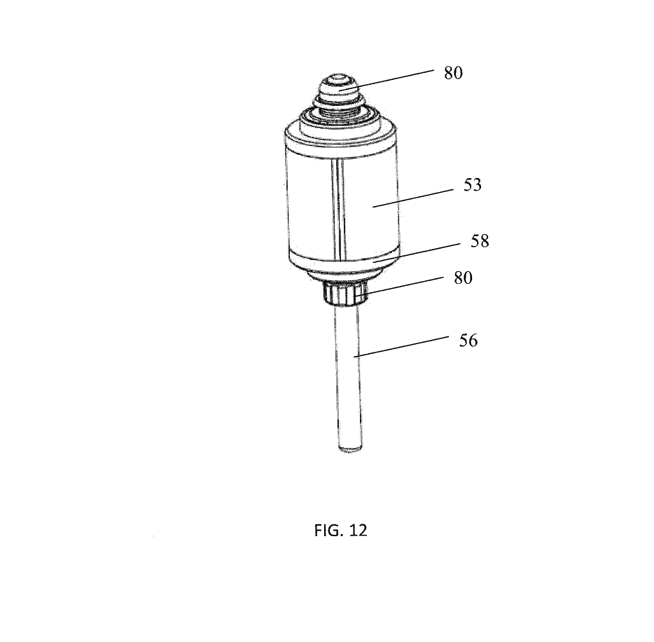

Bearing seats are disposed in the first end cap 33 and the second end cap 35, for mounting of bearings 80 (FIG. 12), respectively. The two bearings 80 support the rotary shaft 56 such that the rotary shaft 56 is capable of rotation relative to the stator 30.

In the present embodiment, the motor 500 of the present invention is a single phase synchronous motor. The stator core 32 of the stator has two pole portions 37, 38. Inner surfaces of the pole portions 37, 38 are arc pole surfaces.

Referring to FIG. 12 to FIG. 14, the rotor 50 includes the rotary shaft 56, a rotor main body attached around the shaft 56, and a buffering device 65. The rotor main body is attached around the rotary shaft 56. The two bearings 80 are located outside of opposite ends of the rotor main body, respectively. The rotary shaft 56 is supported by the two bearings 80 so as to be rotatable relative to the rotor main body. The rotor main body has a loose/sliding fit with the rotary shaft 56 and, as a result, the rotor main body and the rotary shaft 56 have a significant rotation speed difference during the course of starting or stopping.

The buffering device 65 is disposed within the rotor main body and radially located between the rotary main body and the rotary shaft 56. The buffering device 65 is attached around the rotary shaft 56. The buffering device 65 has a first end directly or indirectly connected to the rotor main body so that the first end of the buffering device 65 is capable of synchronous rotation with the rotor main body. A second end of the buffering device 65 is directly or indirectly connected to the rotor shaft 56, so that the second end of the buffering device 65 is capable of synchronous rotation with the rotary shaft 56. Therefore, the presence of the buffering device 65 can synchronize with time delay the rotation speeds between the rotor main body and the rotary shaft 56, which can effectively reduce or eliminate the occurrence of the startup failure or stall of the motor 500. The buffering device 65 is disposed in the interior of the rotor main body, without changing outside structures of the rotor 50 and the motor 500, and the load can be directly connected to one end of the rotary shaft 56, which results in a more compact structure of the motor 500 and facilitates repairmen and replacement of the motor 500.

In this embodiment, the rotor main body includes a support member 58 and a pair of permanent magnets 53. The support member 58 includes a hollow cylindrical main portion 581. The permanent magnets 53 are mounted to an outer side of the main portion 581. The two sleeve rings 582, 583 are attached around two ends of the outer side of the main portion 581 for axially positioning the permanent magnet members 42. Specifically, the two rings 582, 583 have opposed grooves. Two ends of the permanent magnet member 53 form protrusions corresponding to the grooves. The protrusions are engaged in the grooves such that the permanent magnets 53 can be firmly positioned at the outer side of the main portion 581 of the support member 58. Preferably, the support member 58 is a part that is injection-molded over the permanent magnets 53.

Two bearings 80 are respectively mounted within two ends of the main portion 581. The bearings 80 have a sliding fit with the rotary shaft 56, which allows the support member 58 to freely rotate relative to the rotary shaft 56 without producing too large jumping, while ensuring the reliability and lifespan of the motor.

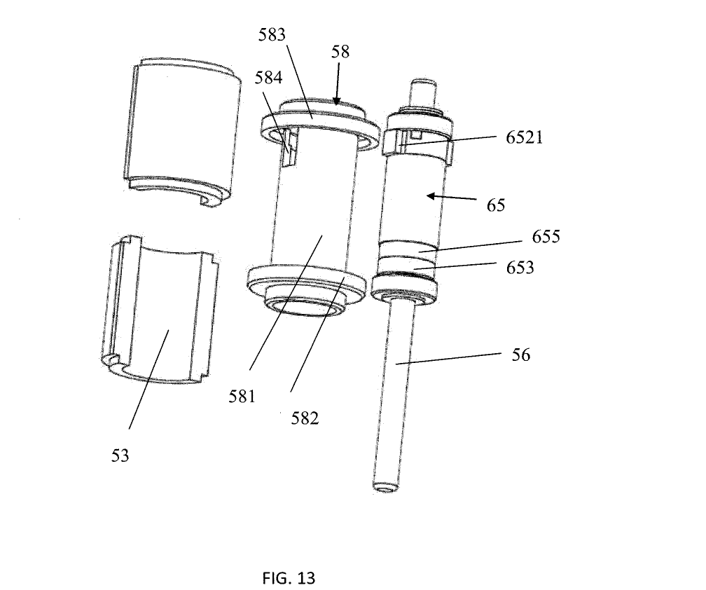

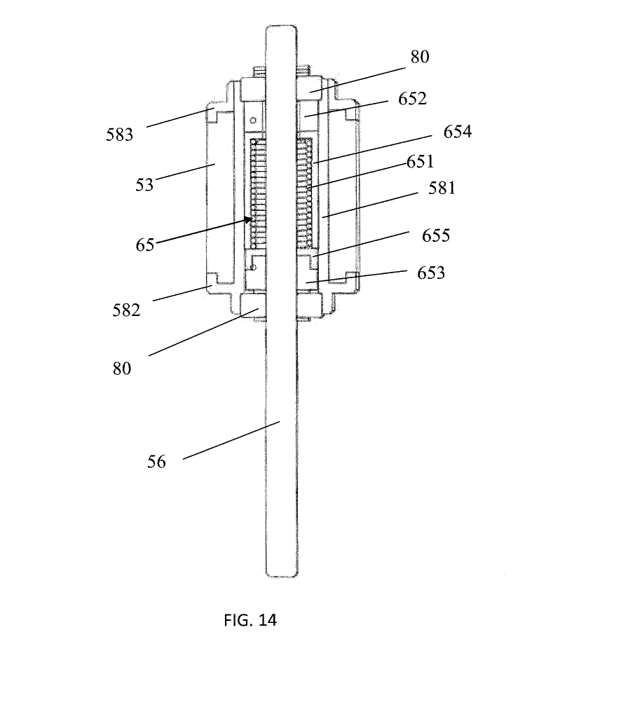

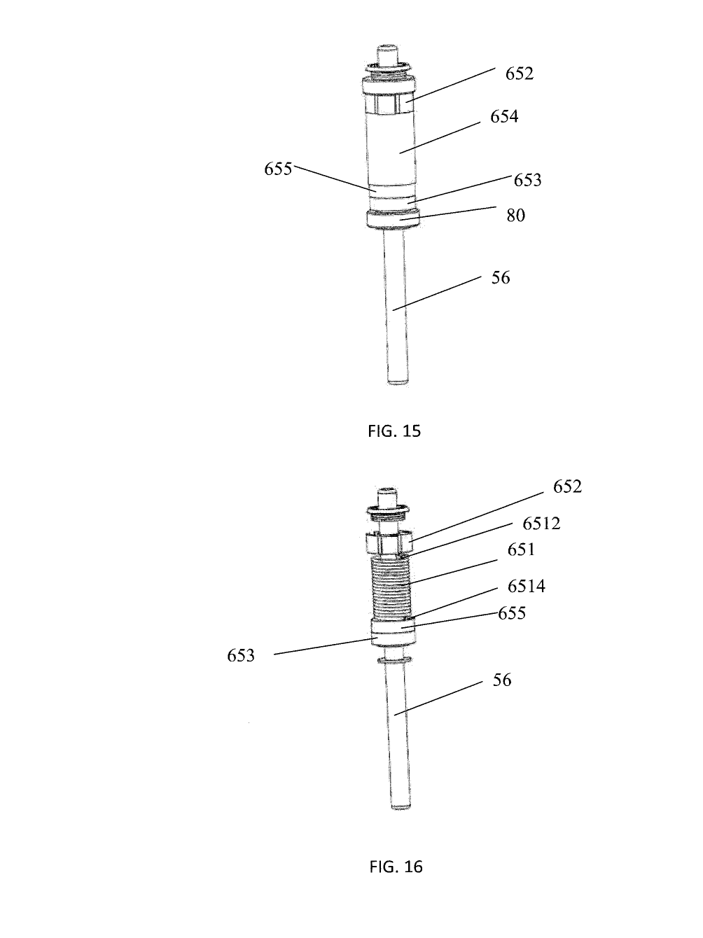

Referring to FIG. 14, FIG. 15, and FIG. 16, in this embodiment, the buffering device 65 includes a buffering member 651, a ring-shaped first connecting base 652, and a ring-shaped second connecting base 653. The main portion 581 of the support member 58 surrounds an outer circumferential side of the buffering member 651 to protect the buffering member 651. A first end 6512 of the buffering member 651 is connected to the first connecting base 652, a second end 6514 of the buffering member 651 is connected to the second connecting base 653, the first connecting base 652 is movably attached around the rotary shaft 56, and the second connecting base 653 is fixedly attached around the rotary shaft 56. The first connecting base 652 and the second connecting base 653 are located at inner sides of the two bearings 80 to axially position the two bearings 80, which can prevent axial displacement of the rotor main body. The second connecting base 653 is fixedly connected to the rotary shaft 56, such that the second end of the buffering member 651 can rotate synchronously with the rotary shaft 56. The first connecting base 652 is fixedly connected to the support member 58 so as to rotate synchronously with the support member 58. Therefore, the buffering member 651 is configured to buffer the rotation speed difference between the rotor main body and the rotary shaft 56. In this embodiment, the main portion 581 of the support member 58 has two cutouts 584 (FIG. 13) positioned symmetrically about an axis of the main portion 581. The first connecting base 652 includes two protruding blocks 6521 corresponding to the cutouts 584. The protruding blocks 6521 fit in the cutouts 584, such that the buffering member 651 can rotate synchronously with the rotor main body. It should be understood that the support member 58 can be connected with the first connecting base 652 through another structure.

The buffering member 651 includes an elastic member with a shape restoring characteristic. Preferably, the elastic member is a helical spring movably attached around the rotary shaft 56. When the stator winding 34 is energized, the rotor main body including permanent magnets 53 and supporting member 58 rotates under the driving of the electromagnetic field generated by the stator 30. One end of the rotary shaft 56 is directly or indirectly connected with the load such as a fan so that the rotary shaft 56 has a large inertia, and the rotary shaft 56 has a loose/sliding fit with the rotor main body. Therefore, at the period of startup, the rotation speed of the rotor main body is greater than the rotation speed of the rotary shaft 56, i.e. a rotation speed difference exists between the rotor main body and the rotary shaft 56. The helical spring 651 is pulled by the rotation of the rotor main body, such that the first end 651a of the helical spring is tightened with its inner diameter gradually decreasing. As a result, the second end 651b of the helical spring is also gradually tightened, and the rotation speed of the rotator main body is eventually synchronous with the rotation speed of the rotary shaft 56. When the stator winding 34 is de-energized and the motor 500 stops from an operation state, because of the large rotational inertia of the load, the rotation speed of the rotary shaft 56 is greater than the rotation speed of the rotor main body, i.e. a rotation speed difference exists between the rotor main body and the rotary shaft 56, such that the second end 65 lb of the helical spring is gradually loosened with its inner diameter gradually increasing. As a result, the first end 651a of the helical spring is also gradually loosened, and the rotation speed of the rotator main body is eventually synchronous with the rotation speed of the rotary shaft 56. The support member 58 surrounds the helical spring 651, which prevents the helical spring 651 from being damaged due to over-increasing of its inner diameter.

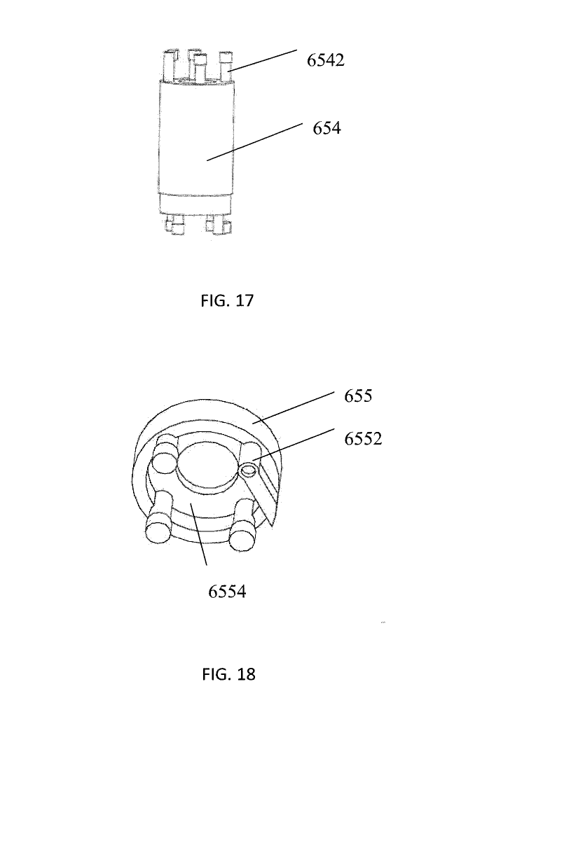

The buffering device 651 further includes a damping member 654. The damping member 654 is movably attached around the buffering member 651 and between the buffering member 651 and the main portion 581 of the support member 58 for buffering the striking of the buffering member 651 to the main portion 581 of the support member 58, thereby achieving shock-absorbing and noise reduction results. One end of the damping member 654 is connected to the first connecting base 652. Referring also to FIG. 17, the damping member 654 includes a connecting pin structure 6542, the first connecting base 52 includes a through-hole structure corresponding to the connecting pin structure 6542, and the connecting pin structure 6542 engages with the through-hole structure to strengthen/reinforce the connection between the damping member 654 and the first connecting base 652 thus preventing the damping member 654 from becoming disengaged from the first connecting base 652. The other end of the damping member 654 is connected to a connecting base 655. Referring to FIG. 17 and FIG. 18, the connecting base 655 is connected to the second connecting base 653. The connecting base 655 also includes a connecting pin structure 6552 and a recessed portion 6554. The second connecting base 653 includes a through-hole structure and protruding portion corresponding to the connecting pin structure 6552 and the recessed portion 6554. The connecting pin structure 6552 engages with the through-hole structure, and the protruding portion engages with the recessed portion 6554, which reinforces the connection between the connecting base 655 and the second connecting base 653 thus preventing the damping member from becoming disengaged.

Preferably, the material of the damping member 654 and the connecting base 655 is a soft material such as rubber or foamed plastic.

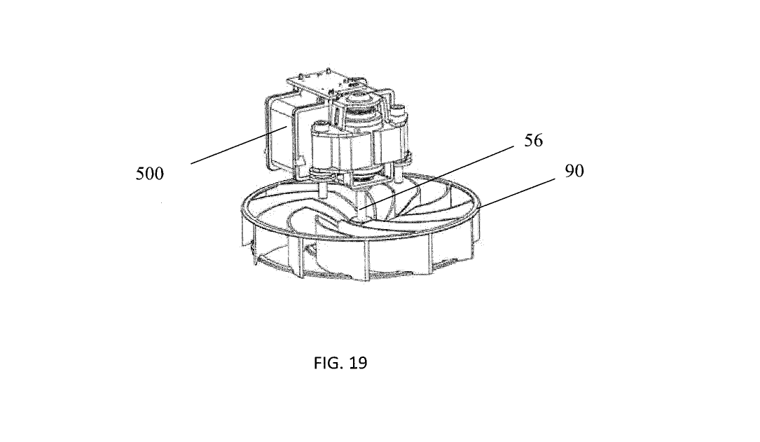

FIG. 19 illustrates a large load electrical device using the motor 500 of the present invention. In this embodiment, the large load electrical device is a fan assembly. The fan assembly includes the motor 500 and an impeller 90 driven by the motor 500. The buffering device 65 of the motor 500 is disposed within the interior of the motor, preferably within the interior of the rotor main body. Therefore, it is easy to mount one end of the rotary shaft 56 of the motor 500 to the fan 90. In this embodiment, although an outer diameter of the impeller 90 is significantly greater than the size of the motor 500, the startup failure or stall of the motor 500 when driving the large-sized impeller 90 can be effectively reduced or avoided due to the using of the buffering device 65. In this embodiment, an outer diameter of the impeller 90 is significantly greater than the size of the motor 500 perpendicular to the rotary shaft of the rotor. The area occupied by the impeller 90 perpendicular to the rotary shaft of the rotor is greater than twice, preferably three or four times of the area occupied by the motor 500 perpendicular to the rotary shaft of the rotor. The buffering device 65 mounted in the motor 500 can effectively reduce or eliminate startup failure or stall of the motor 500.

Understandably, the motor 500 of this embodiment may be used to drive the fan of the first embodiment and the motors 10, 200, 300 and 400 of the before embodiments may be used to drive the impeller of this embodiment.

It should be understood that, although particularly suitable for a single phase synchronous motor, the present invention may be used in other applications where a motor having small output torque drives a load with large rotational inertia such as power tools, gearboxes or drainage pumps.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. An electric motor comprising:
a stator; and
a rotor rotatably mounted to the stator, the rotor comprising:
a rotary shaft;
a rotor main body attached around the rotary shaft, the rotor main body and the rotary shaft being loosely fit with each other thus allowing a rotation speed difference therebetween; and
a buffering device arranged between the rotor main body and the rotary shaft for synchronizing rotation speeds of the rotor main body and the rotary shaft in a time-delayed manner.

2. The motor of claim 1, wherein the stator comprises a stator core and a stator winding wound on the stator core, and the rotor main body comprises permanent magnetic poles formed by permanent magnetic material or a conductor made of soft magnetic material such that the rotor main body is capable of rotating under interaction between the rotor main body and the stator.

3. The motor of claim 1, wherein the stator comprises a stator core, a stator winding wound on the stator core and a pair of end caps disposed on opposite sides of the stator core, the buffering device being axially disposed between the end caps.

4. The motor of claim 3, wherein the motor further includes a pair of bearings mounted in the end caps respectively, and the rotary shaft is rotatably mounted to the end caps via the bearings, the buffering device being axially located between the stator core and one of the end caps.

5. The motor of claim 4, wherein the rotor further comprises a support member, the rotor main body is mounted on the support member, the support member is attached around the rotary shaft, one end of the buffering device is connected to the support member, and the other end of the buffering device is connected to the rotary shaft.

6. The motor of claim 5, wherein the support member comprises an extension portion extending from one end of the support member, a receiving space being formed between the extension portion and the rotary shaft, the buffering device being received within the receiving space.

7. The motor of claim 2, wherein the rotor further comprises a tube made of abrasion resistant material, the tube being radially arranged between the rotor main body and the rotary shaft.

8. The motor of claim 7, wherein the buffering device is attached round one end of the tube extending out of the rotor main body.

9. The motor of claim 8, wherein the motor further comprises a sleeve made from a vibration damping material, the sleeve is attached around a portion of the tube extending out of the rotor main body, and the buffering device is attached around the sleeve.

10. The motor of claim 2, wherein the motor further comprises an end cap attached to one end of the stator core and a mounting base, one end of the rotary shaft is rotatably mounted to the end cap and the other end of the rotary shaft is connected to the mounting base for rotating with the mounting base synchronously, the rotor further comprises a support member movably attached around the rotary shaft, the rotor main body is fixedly mounted on the support member, the support member comprises an extension portion extending from one end of the support member away from the end cap, a receiving space is formed between the rotary shaft and the extension portion, and the buffering device is received in the receiving space with one end of the buffering device connected to the support member and the other end of the buffering device connected to the mounting base.

11. The motor of claim 1, wherein the buffering device comprises a helical spring attached around the rotary shaft.

12. The motor of claim 1, wherein the motor further comprises a positioning member and a vibration damping ring, the positioning member is fixed to a portion of the rotary shaft extending out of the rotor main body for limiting axial movement of the rotor main body relative to the rotary shaft, and the vibration damping ring is disposed between the rotor main body and the positioning member.

13. The motor of claim 1, wherein the motor is a single phase synchronous motor.

14. The motor of claim 1, wherein the buffering device is located within the rotor main body and radially between the rotary shaft and the rotor main body.

15. The motor of claim 14, wherein the buffering device includes a buffering member movably attached round the rotary shaft and a damping member, the damping member is movably attached around the buffering member and radially located between the buffering member and the rotor main body.

16. The motor of claim 15, wherein the buffering device further comprises a first connecting base and a second connecting base connected respectively to two ends of the buffering member, the first connecting base is connected to the rotor main body for rotating with the rotor main body synchronously, and the second connecting base is connected to the rotary shaft for rotating with the rotor shaft synchronously.

17. The motor of claim 16, wherein the rotor further comprises a support member movably attached around the rotary shaft, the rotor main body is mounted on the support member, the buffering member, the damping member and the first and second connecting bases being arranged within the support member.

18. An electrical apparatus comprising:
a motor comprising:
a stator;
a rotor comprising a rotary shaft, and a rotor main body attached around the rotary shaft, the rotor main body capable of rotation under action of the stator, the rotor main body and the rotary shaft being loosely fit with each other such that the rotor main body is capable of rotation relative to the rotary shaft during startup of the motor; and
a buffering device having one end directly and indirectly connected to the rotor main body and the other end directly or indirectly connected to the rotary shaft for synchronizing rotation speeds of the rotor main body and the rotary shaft in a time-delayed manner; and
a load mounted to one end of the rotary shaft of the motor and being capable of synchronous rotation with the rotary shaft.

19. The electrical apparatus of claim 18, wherein the electrical apparatus comprises a fan or impeller to which the rotary shaft of the motor is mounted.

20. The electrical apparatus of claim 19, wherein the area occupied by the fan or impeller perpendicular to the rotary shaft of the rotor is greater than twice of the area occupied by the motor perpendicular to the rotary shaft of the rotor.
